(19) United States
(12) Patent Application Publication
(10) Pub. No.: US 2017/0330147 A1
(43) Pub. Date: Nov. 16, 2017

(54) SYSTEM AND METHOD OF ANALYSIS AND RECOMMENDATION FOR DISTRIBUTED EMPLOYEE MANAGEMENT AND DIGITAL COLLABORATION

(71) Applicant: SYKES ENTERPRISES INCORPORATED, TAMPA, FL (US)

(72) Inventors: J. Shelton HOOK, Tampa, FL (US); David PEARSON, Tampa, FL (US); Richard SADOWSKI, Tampa, FL (US); Stephen BERDY, Tampa, FL (US); Joseph FLASKA, Tampa, FL (US); James SOMERS, Tampa, FL (US); Brooke AKER, Tampa, FL (US); Martin HENDRICKSE, Tampa, FL (US); Michael RITTERBUSCH, Tampa, FL (US); Eric PALACIO, Tampa, FL (US)

(73) Assignee: SYKES Enterprises Incorporated, Tampa, FL (US)

(21) Appl. No.: 15/402,210

(22) Filed: Jan. 9, 2017

Related U.S. Application Data
(60) Provisional application No. 62/276,179, filed on Jan. 7, 2016.

(51) Int. Cl. G06Q 10/10

(52) U.S. Cl. CPC G06Q 10/101

(57) ABSTRACT

A customer contact management platform combining desktop and telephony virtualization with employee and client portals. The portals provide access to tools and information for users to provide support to enterprise clients. The platform includes a set of web-based employee, client, and work portals that allow employees of the service provider to access information, schedules, networks, telephony, applications, and tools so they can perform work for their clients.

### CROSS REFERENCE TO RELATED APPLICATIONS

This application is a non-provisional application of copending provisional application 62/276179 filed Jan. 7, 2016 which is incorporated herein by reference.

### FIELD OF INVENTION

This invention relates to the field of customer contact management systems.

### SUMMARY OF INVENTION

The inventive platform combines desktop and telephony virtualization with employee and client portals. The portals provide access to tools and information for users to provide support to enterprise clients. The platform includes a set of web-based employee, client, and work portals that allow employees of the service provider to access information, schedules, networks, telephony, applications, and tools so they can perform work for their clients.

### BRIEF DESCRIPTION OF THE DRAWINGS

For a fuller understanding of the invention, reference should be made to the following detailed description, taken in connection with the accompanying drawings, in which:

FIG. 1 is a diagram of an illustrative computer system employing the inventive platform;

FIG. 2 illustrates the portals of the inventive platform which provide access to tools and information employees need to provide support to clients;

FIG. 3 represents an illustrative portal of the inventive platform;

FIG. 4 represents an illustrative portal of the inventive platform;

FIG. 5 represents an illustrative Agent Adaptive Workspace;

FIG. 6 represents an illustrative Agent Support Adaptive Workspace;

FIG. 7 represents an illustrative Intelligent Monitor portal;

FIG. 8 is an illustration of a Needs Help model;

FIG. 9 illustrates examples of query components of the Intelligent Offers portal;

FIG. 10 is a diagram depicting the Intelligent Offer Entity Relationship;

FIG. 11 is an illustrative Employee Tile;

FIG. 12 is a diagram showing how the Employee Tile data is logically organized;

FIG. 13 is a diagram of the agent marketplace;

FIG. 14 is a depiction of a machine learning model for 3 different sets of constraints yielding 3 different best-fit solutions;

FIG. 15 is a login screen;

FIG. 16 is an authentication screen;

FIGS. 17A and 17B illustrate the Login processing flow;

FIG. 18 illustrates the Login GUI systems matrix;

FIG. 19 illustrates the foundational analytics of the inventive platform;

FIG. 20 illustrates the Global Transaction Application (GTA);

FIG. 21 illustrates the GTA processing flow;

FIG. 22 is a basic ER diagram showing the relationship between the core tables/objects within the Global Transaction System;

FIG. 23 illustrates an example Phone Transaction with typical events;

FIG. 24 shows the Intelligent Orchestration which manages all of the Employee Offers, scheduled tasks, and analytic work associated with the inventive platform;

FIG. 25 is a diagram of the architecture which includes four main layers: (1) Process Definition, (2) Process Engine, (3) Rules Engine and (4) Interface Services; and

FIG. 26 illustrates the process definition.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized.

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

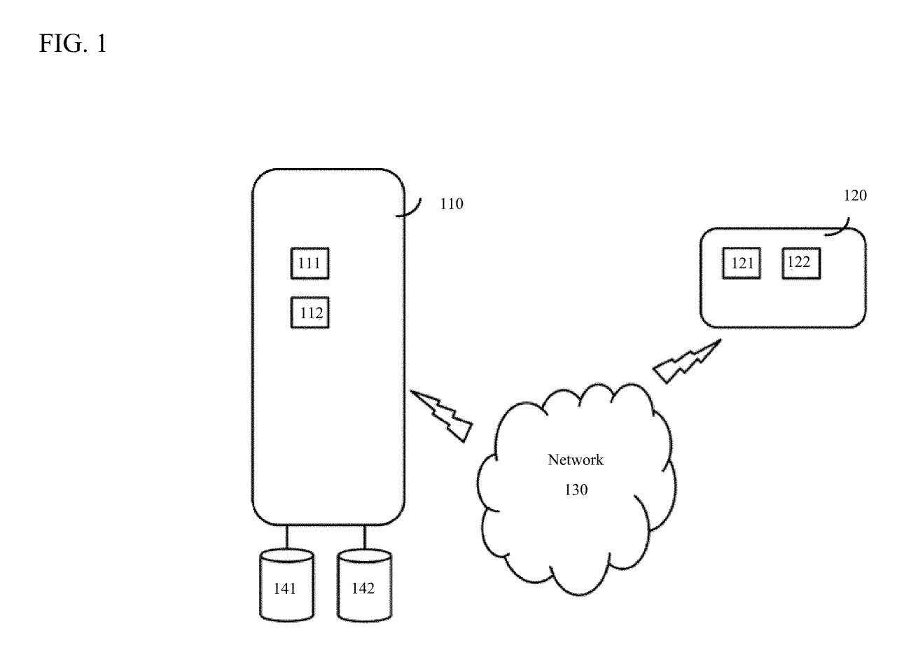

FIG. 1 is a diagram showing an example of a computing system in which the present subject matter can be implemented. As shown, the computing system includes a back-end component 110, such as for example one or more data servers, or that includes a middleware component, such as for example one or more application servers, or that includes a front-end component 120, such as for example one or more client computers having a graphical user interface or a Web browser through which a user can interact with an implementation of the subject matter described herein, or any combination of such back-end, middleware, or front-end components. These components may include one or more processors 111, 121, and memory 112, 122 (e.g. computer readable medium for storing instructions). The computing system may also include one or more data storage 141, 142. The client and server are generally, but not exclusively, remote from each other and typically interact through a communication network 130, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the claims may include other implementations or embodiments.

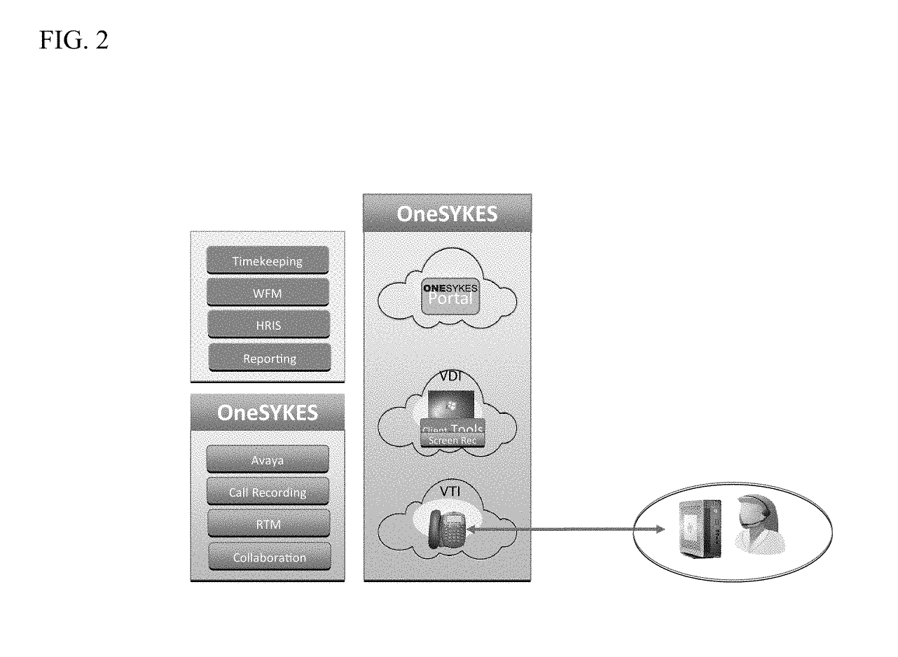

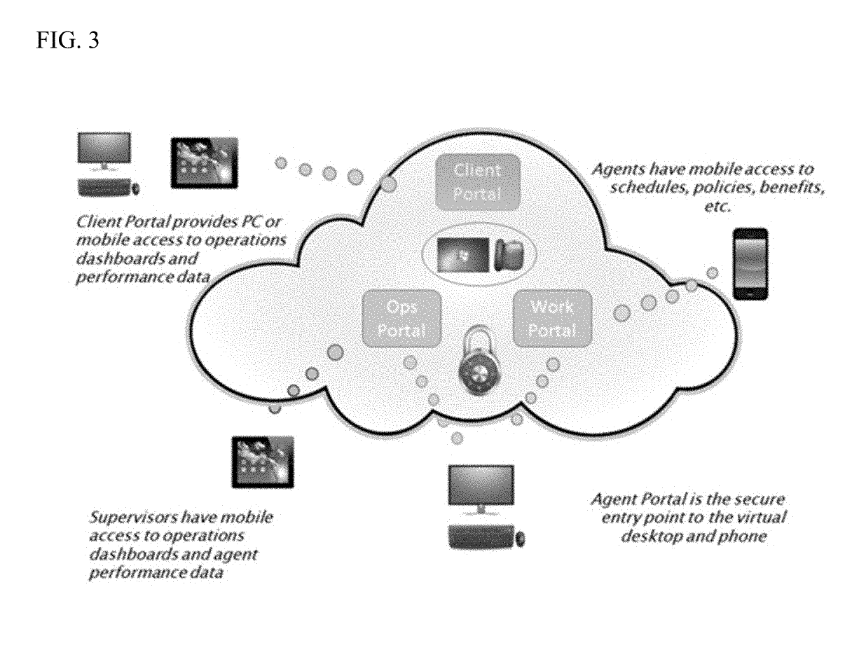

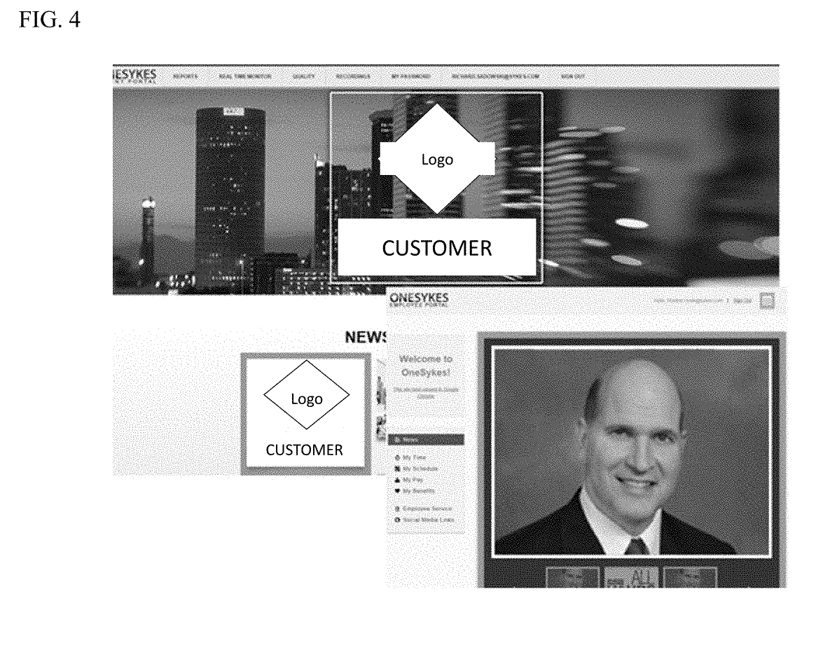

Referring now to FIGS. 1 through 4, the invention includes a desktop and telephony platform that affords a service provider and its employees with centralized user management, data center consolidation, and a global common platform. Virtual PC, virtual Phone, and user-centric portals are all delivered from the cloud. Several components of the inventive platform include Adaptive Workspaces, Intelligent Monitor, Employee Tiles, Intelligent Offers, Employee Marketplace, Foundational Analytics, Intelligent Orchestration, and Seamless Login. While the following descriptions illustrate the inventive platform in the context of a customer contact management solution, other uses are also contemplated.

Adaptive Workspaces

Many customer contact management solutions use different tools and applications to support the needs of its clients and employees. Many times, these applications are designed to achieve a goal without regard for the experience of the individuals using them. The inventive platform utilizes a User Experience Design Methodology (UX) that focuses on user needs while still obtaining the desired business goal.

To this aim, the inventive platform utilizes Adaptive Workspaces. Adaptive Workspaces intelligently provide a user with the information and tools necessary to efficiently complete a task. Once the task is completed, the Adaptive Workspace gracefully gets out of the user's way allowing him or her to continue with the next task.

The inventive platform also provides a real-time management console (Intelligent Monitor) to help manage a blended roster of virtual and brick and mortar agents. The goal is to combine this real-time monitoring tool with just-in-time Adaptive Workspaces to increase a team's utilization and profitability.

The Adaptive Workspaces provide:
a. Workspaces with a focus on the user. This methodology is used in creating the user experience component of any application designed for use in the inventive platform;
b. Improved employee satisfaction and efficiency by employing Adaptive Workspaces designed with UX as a central theme. Functionality from multiple applications are combined into a single, task-specific user interface;
c. Measurement of all aspects of application usage, processes, and workflows in order to funnel this data into a foundational analytics framework and intelligently adapt the user's workspace.

Agent Adaptive Workspace

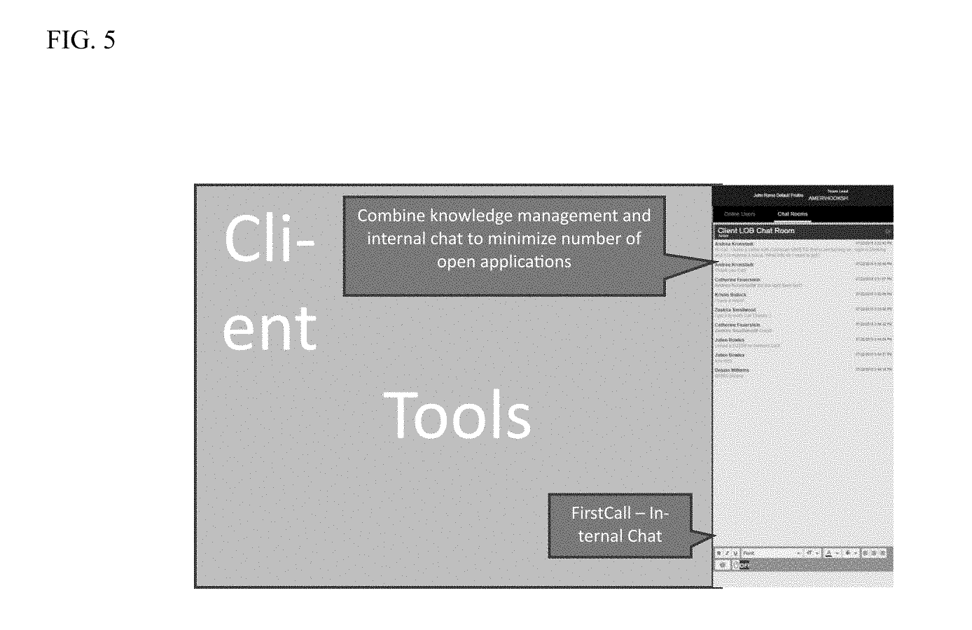

The Agent Adaptive workspace, shown in FIG. 5, combines a global internal chat system and a knowledge management into a single efficient tool that maximizes the remaining workspace for client tools. The global internal chat system is used to facilitate internal communication between the service provider agents and managers. Agents can chat with peers and team managers and use special slash commands to request help. Machine Learning algorithms monitor chat to derive agent sentiment and product trends. The algorithms also predict when an agent needs help from his or her supervisor.

Agent Support Adaptive Workspace

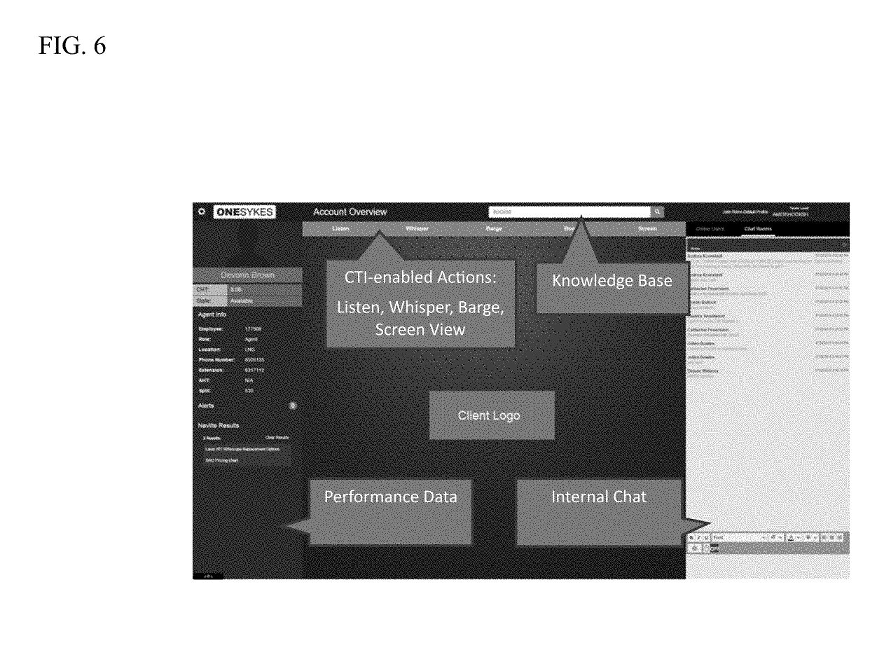

The Agent Support Adaptive Workspace, shown in FIG. 6, is used by Team Managers to directly support their team. The user interface contains contextual information about the ongoing support contact and the agent. It provides many useful CTI-Enabled tools to allow the Team Manager to understand a given situation and then provide help to the Agent in the most expeditious manner possible.

Real-Time Intelligence

Intelligent Monitor

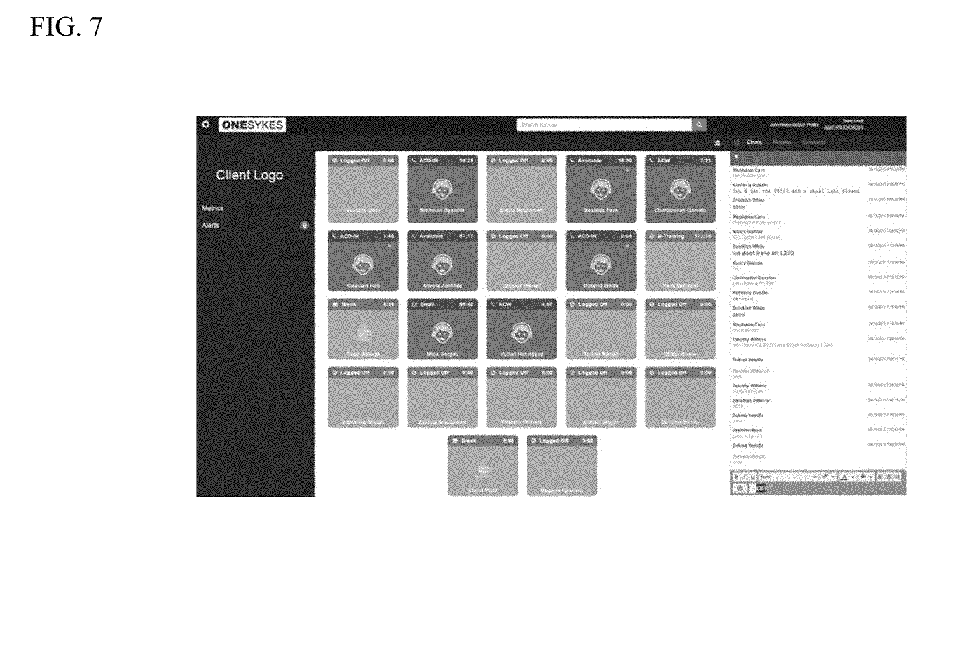

The inventive platform provides a Real-Time Management, see FIG. 7, console to help manage a blended roster of virtual and brick and mortar agents. This tool provides an intelligent way of managing agent productivity. It proactively predicts when an employee needs help based upon tenure, past performance, clickstream data, employee sentiment, and current call conditions. The manager can then assist the employee using the toolset provided by the Agent Support Adaptive Workspace.

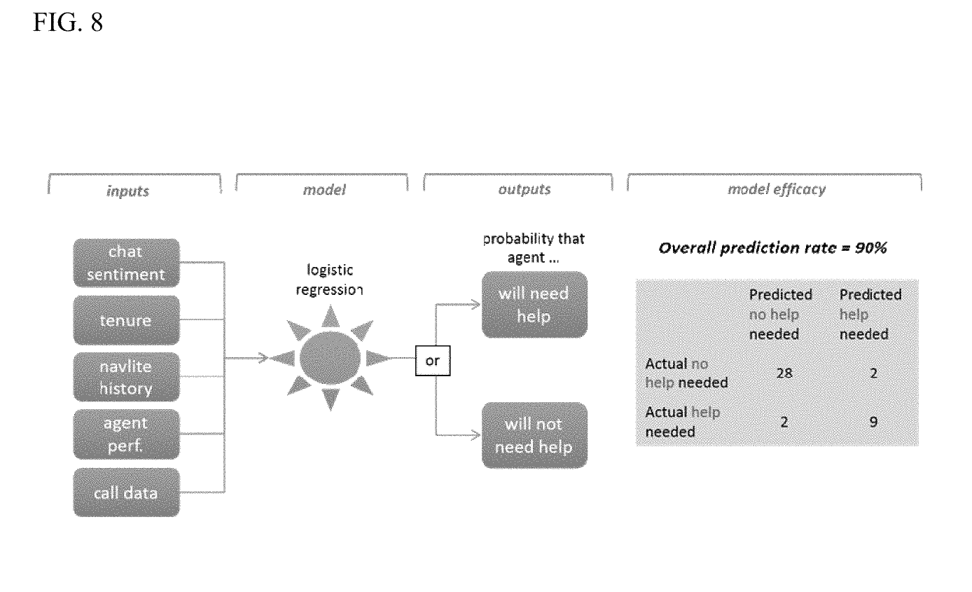

The Agent Needs Help model (ANH), see FIG. 8, predicts the probability an agent will need help during an active customer call. The model is established by looking at historical measures of the length of the call in real time, an agent's current mood as measured from chat streams in real time, the agent's last performance score, agent tenure within the service provider organization and the customer account and the frequency of searches for answers to customer questions. Frequent parameter updates, followed by less frequent variable updates are part of the machine learning routine to keep the accuracy of the ANH as high as possible. The model provides support to the agent, efficiency to the entire call center operation and a more effortless experience for the customer.

Intelligent Offers

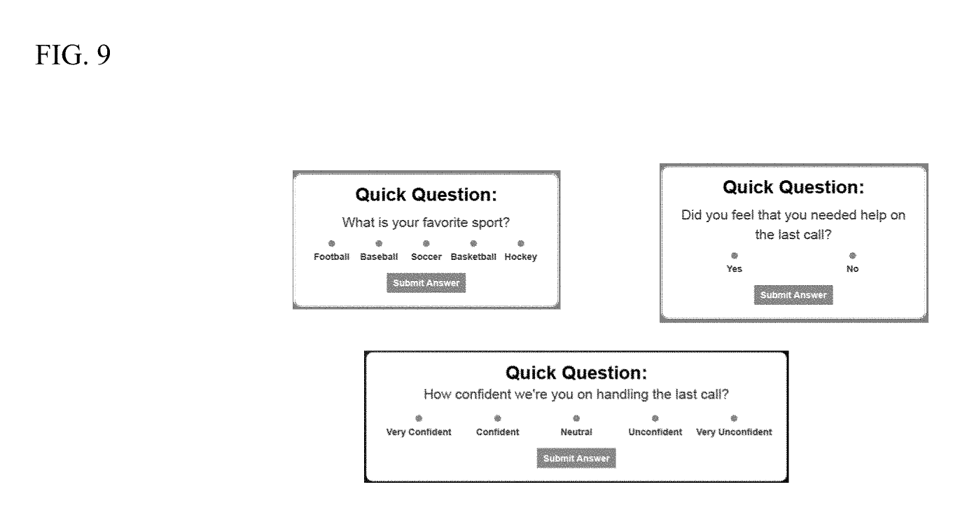

With reference now to FIG. 9, Intelligent Offers are used to minimize employee idle time and gather valuable information about an employee. An Intelligent Offer uses machine learning algorithms to prompt the employee to do one of the following during a predicted lull in their work day. They are called offers because the employee is not required to participate in the offer. The offers are generated via machine learning based upon the employee's tile data, present work conditions and employee sentiment. All responses (and non-responses) are stored for analytical purposes. Employee participation is rewarded via gamification.
a. Provide information on hobbies and preferences.
b. Gather information from a caller.
c. Engage in a mini-training session.
d. Answer a survey question.
e. Play a game.
f. Perform a task such as a peer quality review or call snippet transcription.

The following Intelligent Offer attributes (Table 1) determine when and to whom an offer is presented:

TABLE 1

| Offer Attributes | Description |
|---|---|
| Prerequisite | A given offer will not be presented until |
| | prior required offers have been made |
| | and accepted. |
| Priority | If multiple applicable offers are |
| | available for presentation, the offer with |
| | the highest priority will be presented. |
| Frequency | Determined by cardinality, statistical |
| | measure (for example, the Call Handle |
| | Time is 2 standard Deviations above the |
| | mean so offer up training on Handle |
| | Time Management), or Machine |
| | Learning (for example, the agent is |
| | available and the model predicts that |
| | call volume will be low for the next |
| | hour so offer a peer review session). |
| Expiration | The time that a given offer will be |
| | available after presentation to the agent. |
| | (for example, an offer to collect |
| | customer information is time bound to |
| | the length of the call with that customer |
| | or an offer to play a game is only valid |
| | for the next 10 minutes. |
| Exemption | A given offer will not be presented if |
| | agent or account performance do not |
| | meet acceptable thresholds. |
| Peer Response | A tally of an agent's peers' responses |
| | may be provided to the agent during the |
| | offer presentation (for example,” 57% |
| | of your peers have selected football as |
| | their favorite sport”). |
| Maximum Responses | The maximum allowable responses for |
| | a given offer (for example, we are |
| | offering a Starbucks gift card to the next |
| | 10 people who accept an offer to work |
| | on a new campaign that begins next |
| | Saturday). |
| Badge | The gamification badge associated with |
| | acceptance of a given offer (for |
| | example, the Team Player badge is |
| | associated with an offer to answer a |
| | survey question). |
| Badge Points | The number of points toward a badge |
| | that an agent can earn by accepting a |
| | given offer. |

The machine learning algorithm also uses the following agent, account, and contact interaction attributes (Table 2) to determine when and to whom an offer will be presented.

TABLE 2

| Attribute | Description |
|---|---|
| Agent Performance | Is the agent meeting his or her service level |
| | goals? Note that the algorithm will present |
| | offers to both high and low performing |
| | agents unless an Exemption (discussed |
| | earlier) has been put in place. |
| Account Performance | Is the account or line of business meeting its |
| | service level goals? Note that the algorithm |
| | will present offers to agents on both high and |
| | low performing accounts and lines of |
| | business unless an Exemption (discussed |
| | earlier) has been put in place. |
| Call State | The metrics from the current call - duration, |
| | number of times it has been placed on hold, |
| | length of after call work period. Amount of |
| | time agent was available before each call, |
| | etc. |

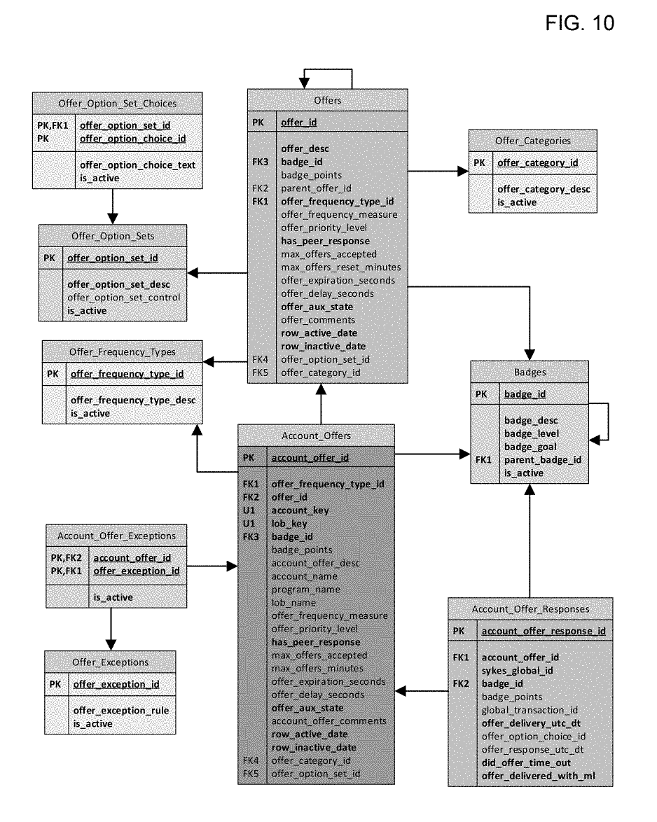

For any given Intelligent Offer, the offer's prerequisites, priority, frequency, expiration, exemptions, and the agent's current work state and performance are all taken into account prior to presenting the offer to the employee. The diagram in FIG. 10 depicts the Intelligent Offer Entity Relationship:

Operational Intelligence

Employee Tiles

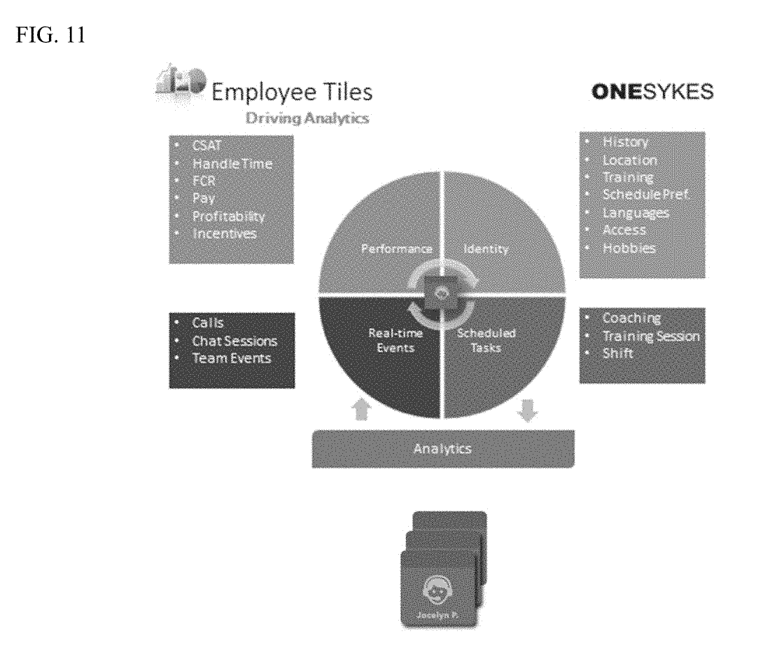

The platform utilizes Employee Tiles, see FIG. 11, to keep track of each employee's lifecycle. This includes Identity, Scheduled Tasks, Real-time Events, and Performance data. This data is analyzed and used for everything from placing the employee in the best work role to providing employees with their schedule preferences to finding potential management candidates. The Employee Tile concept refers both to the UI object representing an employee and to the underlying data structure.

Tile icons are utilized in the platform applications such as the Intelligent Monitor or Intelligent HCM to allow users to quickly view information about an employee that is relevant to their current task and adapted to their work space. Tiles are also the mechanism through which a user can initiate an interaction with an employee, for example screen sharing, chatting or call monitoring. Finally, tiles provide users with a logical access point to an employee's full employment and performance history.

Underneath the tile lies a flexible data structure that brings together heterogeneous data sets from multiple sources. The Employee Tiles are be able to get quick, accurate and complete answers to the following questions about its employees:
a. Who are they?
b. What have they done, and how?
c. What are they doing, and how?
d. What are they able or likely to do, and how?

To this end, the data repository is designed with the following goals in mind:
a. Support the storage of very large volumes of structured and semi-structured data, including real-time data and streams.
b. Enable the seamless and fast retrieval of aggregated information as well as of detailed records for consumption in end-user applications, reporting systems and advanced analytical models.
c. Accommodate the addition of new data points as they become available.

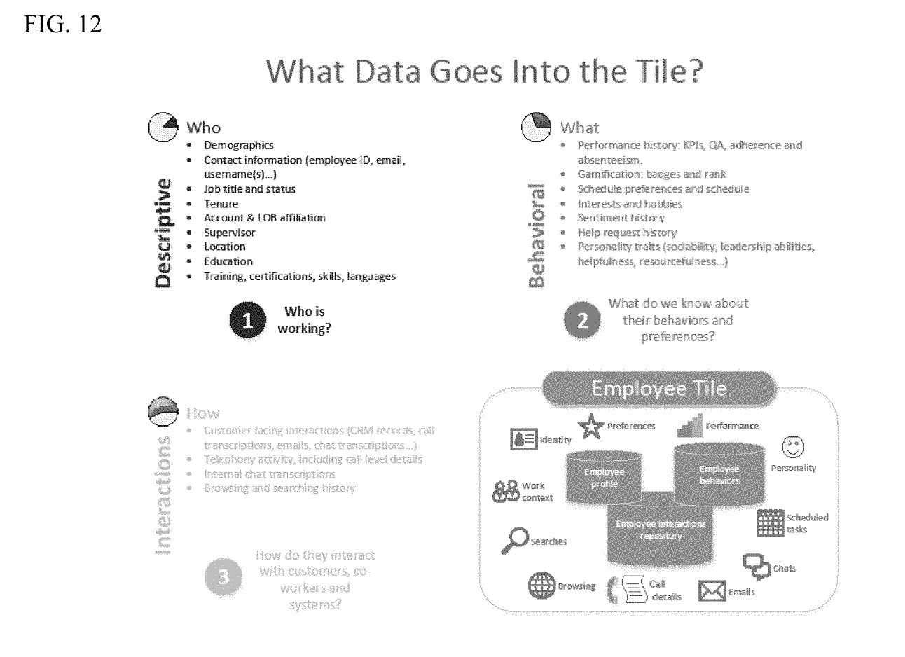

FIG. 12 illustrates how the Employee Tile data is logically organized.

Intelligent Human Capital Management (HCM)

Workforce Management (WFM) is a key component of the Business Process Outsourcing (BPO) industry. This discipline and the associated processes and tools are required to provide agents with work schedules that meet the workload assigned to the service provider by its clients. The inventive platform provides a solution that that can efficiently manage schedules and workload while maximizing agent work-life balance. This is especially important to the virtual agent because many of them have specifically chosen the virtual model in order to better manage work-life balance through non-traditional work schedules. The desired solution will require WFM process innovation and a fully integrated analytics platform. Intelligent HCM creates a marketplace for employee ramps and trades that is driven by analysis of Employee Tiles, Intelligent Offers, and current business conditions.

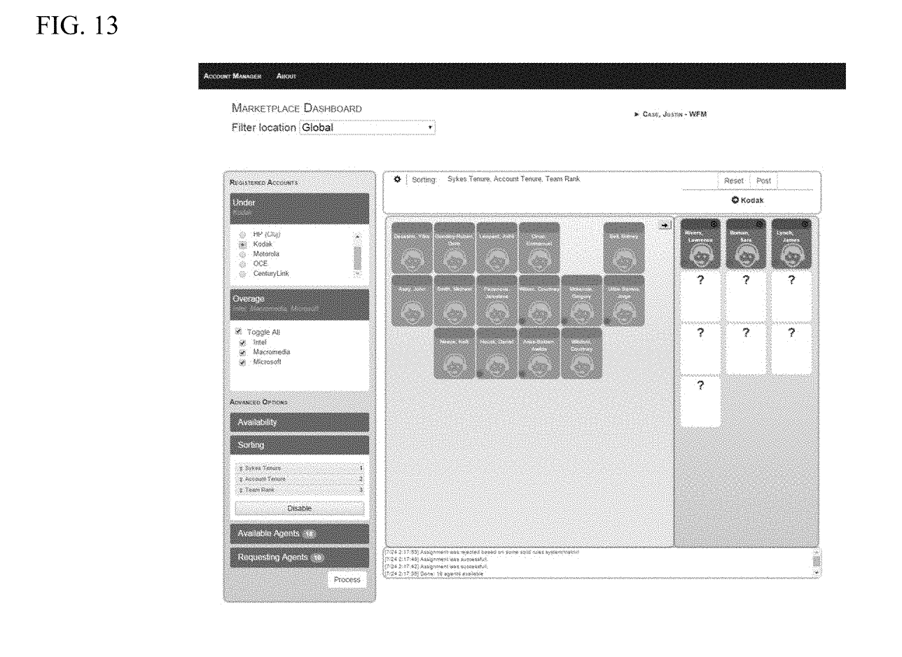

The Intelligent HCM goals are:
a. Provide agents with their schedule preferences whenever feasible to increase employee satisfaction and reduce attrition.
b. Create a marketplace where agents can trade schedules amongst team members to promote work-life balance (see FIG. 13).
c. Incent agents to manage their own schedules to cover the workload assigned to their team.
d. Maintain appropriate staffing levels to meet demand and maintain quality and fairness on each line of business.
e. Provide a mechanism to manage workload balancing for real-time and long-term applications.
f. Provide data to a Global Data Warehouse for analytic purposes such as finding overlapping overstaffed and understaffed intervals in order to find load balancing opportunities.

Utilizing Machine Learning in HCM

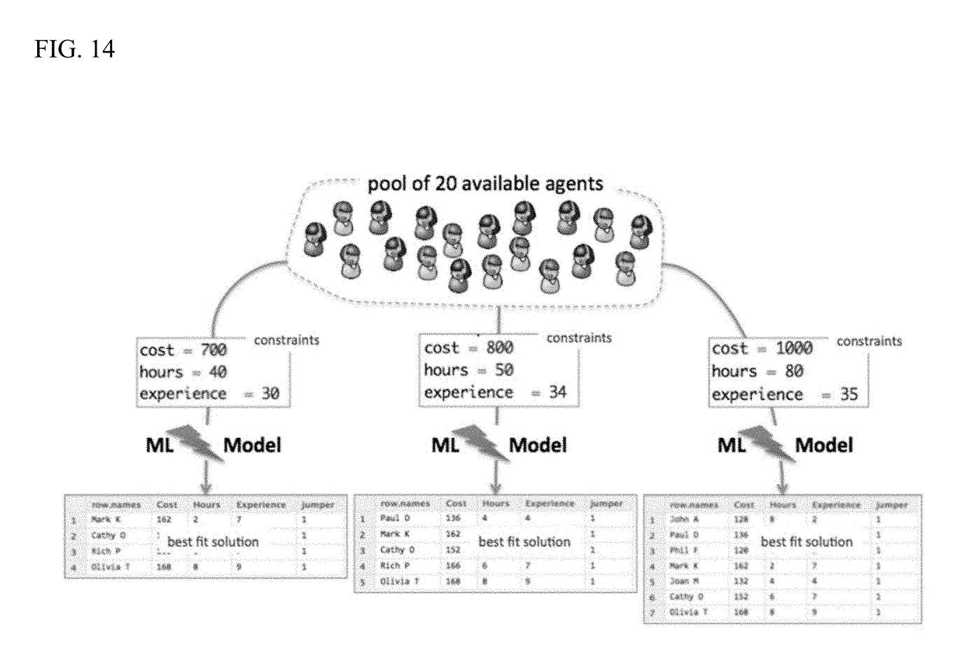

Referring to FIG. 14, the employee marketplace also uses machine learning models to predict and optimize the best fit between employees and accounts. One or more models first measure and predicts when agents may be idle during the day. Account managers can “release” agents to a common pool knowing they are unlikely to be caught short staffed during the prediction period. Other account managers, using the same prediction model, notice they are likely to be understaffed in the near future. They turn to the employee marketplace asking for recommendations from the common pool of available agents. The second machine-learning model picks the optimal combination of agents, their attributes and the constraints of the requesting account and provides a multi-dimensional best fit set of agents for temporary assignment.

A simple depiction of this machine learning model is below for 3 different sets of constraints yielding 3 different best-fit solutions. The operational model uses more than a dozen factors in deciding the best-fit solution.

Seamless Login experience

Agents in the BPO industry are required to perform complex logins and application navigations into many disparate systems and applications. This is often a complex and cumbersome task that varies depending on the work the agent is going to perform as well as the location the agent is working from.

The inventive platform's seamless login experience enables agents to follow a single, intuitive process to login to work from either a service provider facility or their home office. Only one username and password is required to login from the end point and through the VDI.

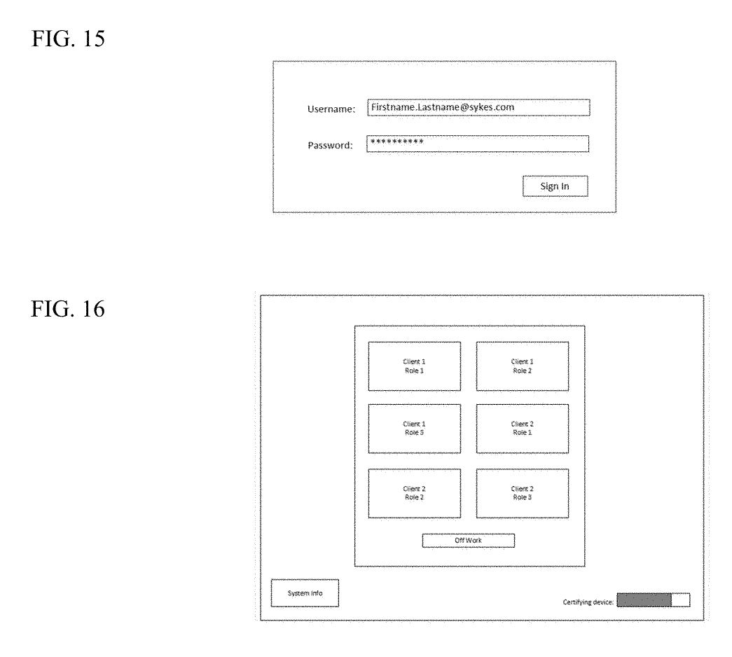

Important points include:
a. The single login solution is secure and multitenant;
b. Employees are provided with a thin client which is completely locked down and contains no reference to the service provider. Upon booting, the user is presented with an input screen to enter their username and password (see FIG. 15).

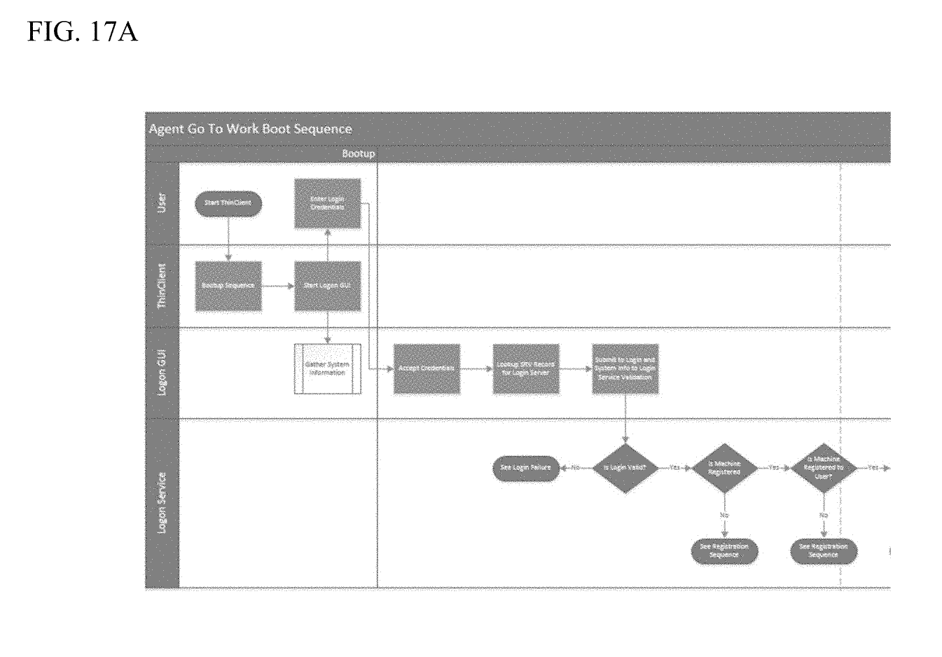

The employee's credentials themselves (e.g. @servco.com) are used as a unique identifier to reference the service provider's organization. @servco.com is used to locate the service provider's server and the credentials are passed to the login service. See FIG. 16.

Once successfully authenticated, the thin client is checked for the following items:
a. Is the machine registered?
b. Is the machine registered to this user?
c. Were the security checks successfully passed?

If any of the above checks fail an alarm message is sent. If all the checks pass, the users potential work assignments are pulled from a central DB and presented to the user to select (click on). Once selected, there is an option to check if the user is scheduled within 30 minutes of the current time.

Next Virtual Private Networks, Virtual Desktop and Virtual Telephony assignments are downloaded from a central server and executed. Once completed, the user is in the CITRIX™ desktop and ready to work.

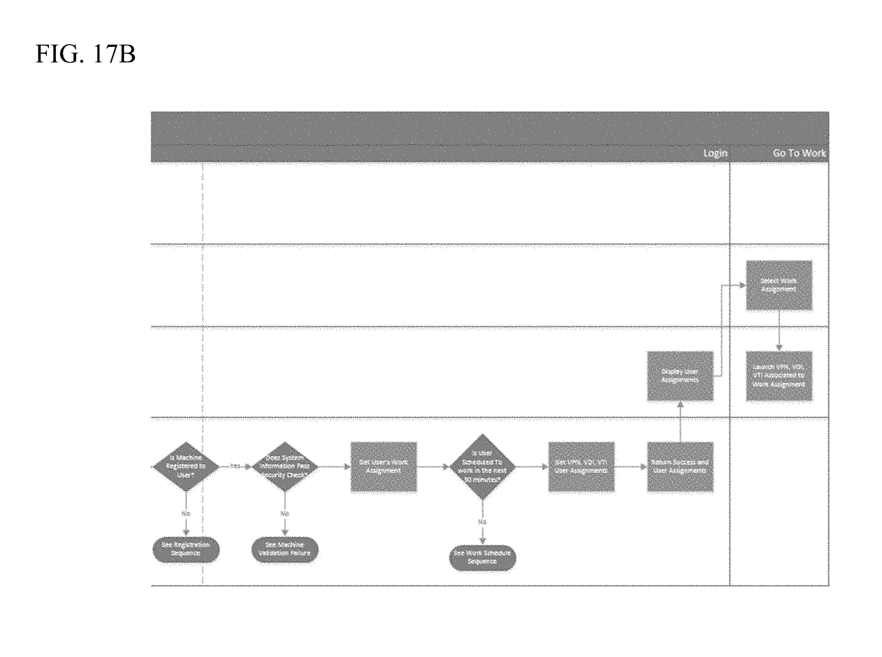

The diagrams in FIGS. 17A and 17B illustrate the Login processing flow.

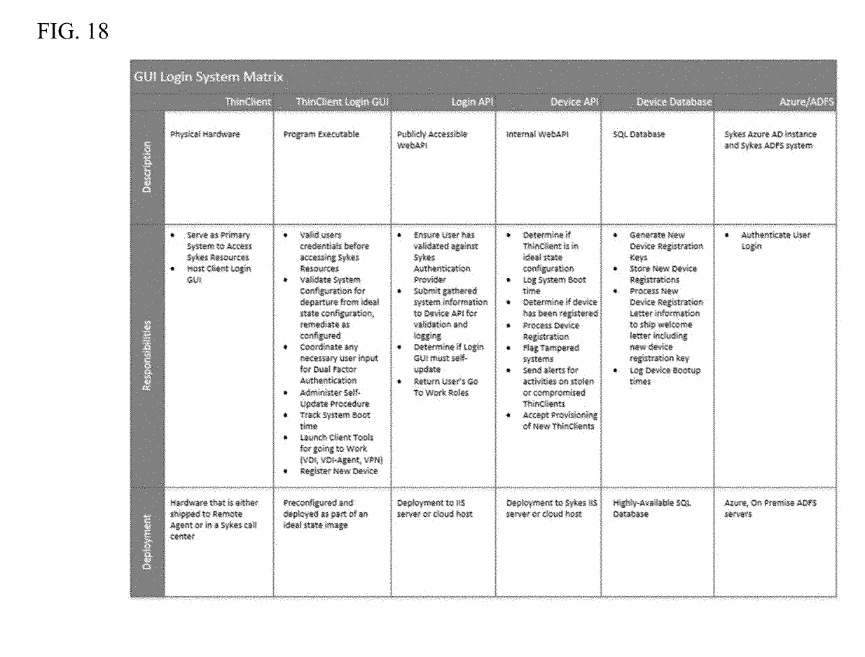

The diagram in FIG. 18 illustrates the Login GUI systems matrix.

Business Intelligence

Foundational Analytics

The BPO industry generates an enormous amount of data; telephony, email, chat, social media, and WFM systems create continuous streams of data. High-levels of employee turnover ensure that applicant tracking, training, and human resources systems are awash with data. Unfortunately, much of this data resides in siloes and there is not an established relationship between common data elements within the silos. This situation denies information to those within an organization that need it to make decisions.

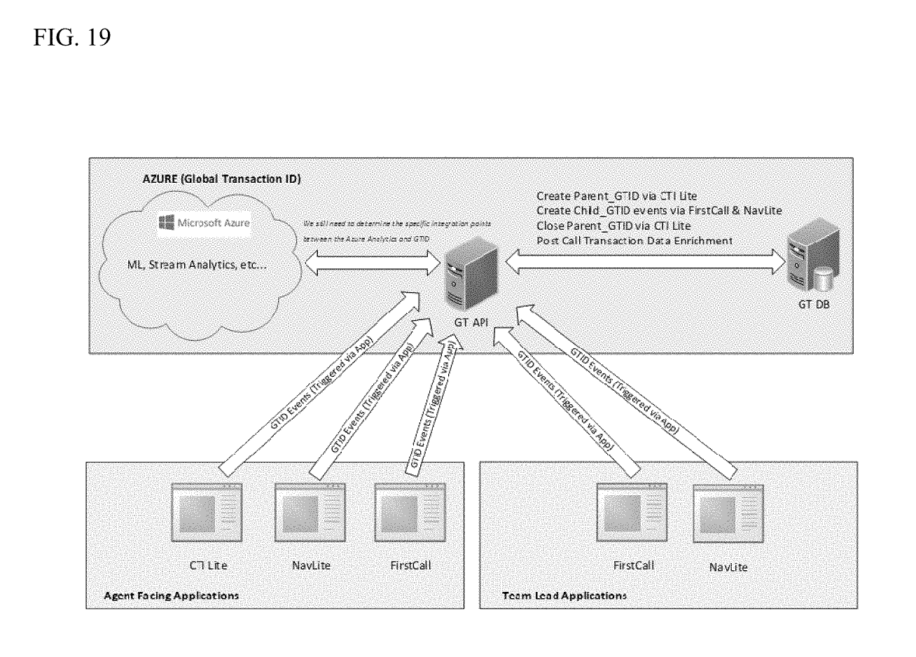

The inventive platform's data-driven enterprise approach utilizes a fully integrated analytics platform (see FIG. 19). The concept of foundational analytics breaks down the walls between data silos and builds relationships between disparate data elements within each source system.

The Foundational Analytics goals are:
a. Provide analytics teams with readily accessible data that is organized, pertinent, accurate, and up to date
b. Link all related work activities for a given task together and associate this work task data with the appropriate Employee Tile.
c. Publish analytics findings globally to allow business leaders to operate in a data-driven environment.

Functionality

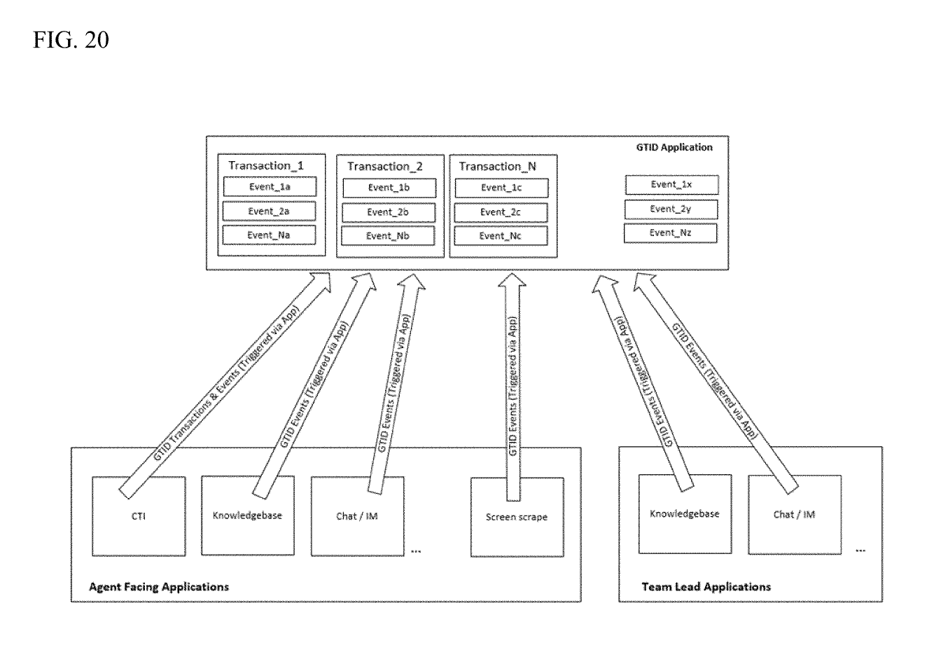

The ability to associate related work activities, for a given task, and to link these tasks to one or more employees is the key proprietary aspect of the inventive platform foundational analytics. This is accomplished by the invention of a system that instantiates both transactions and events (see FIG. 20).

The Global Transaction Application (GTA) is used to record important milestones and events that occur while an agent is providing assistance to a customer. Those events might consist of answering a call, sending a chat, searching for a document, or other customer service related activities. Within the context of the Global Transaction system, actions performed by an agent while assisting a customer are call events. Events can span multiple applications and related events form a transaction. In other words, an event defines an action and a transaction defines a collection of events. Multiple applications are used by customer service representatives during a call and each of those applications may log events to the Global Transaction Application via the Global Transaction API. The GTAPI will correlate related events across multiple applications, based on the data provided by each application.

Events can be one of three mutually exclusive types:
a. Starting event: this type of event signifies the beginning of a related set of events within your application.
b. Ending event: this type of event signifies the end of a related set of events within your application.
c. Standard event: this type of event is neither a starting nor ending event. It is simply an action that should be recorded.

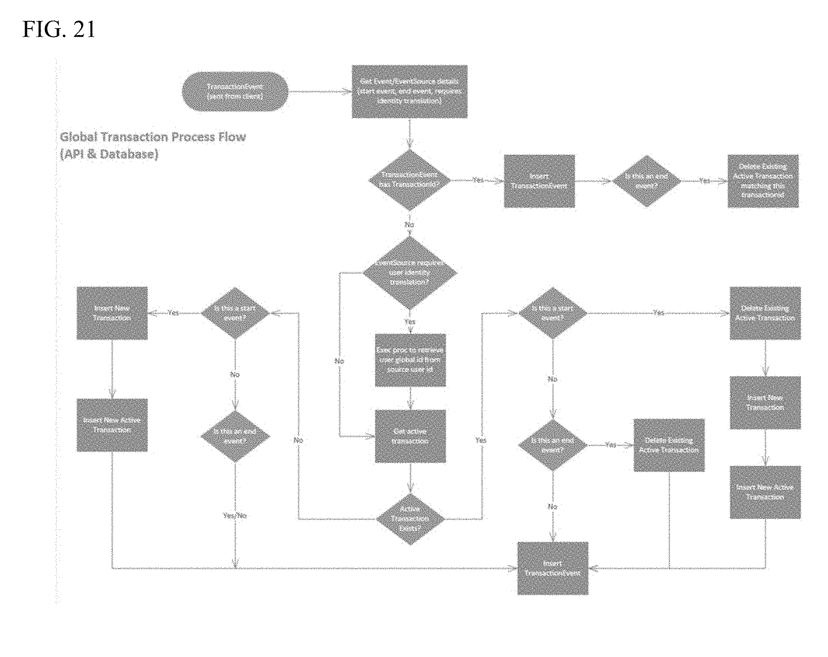

The diagram in FIG. 21 illustrates the GTA processing flow.

ER Diagram

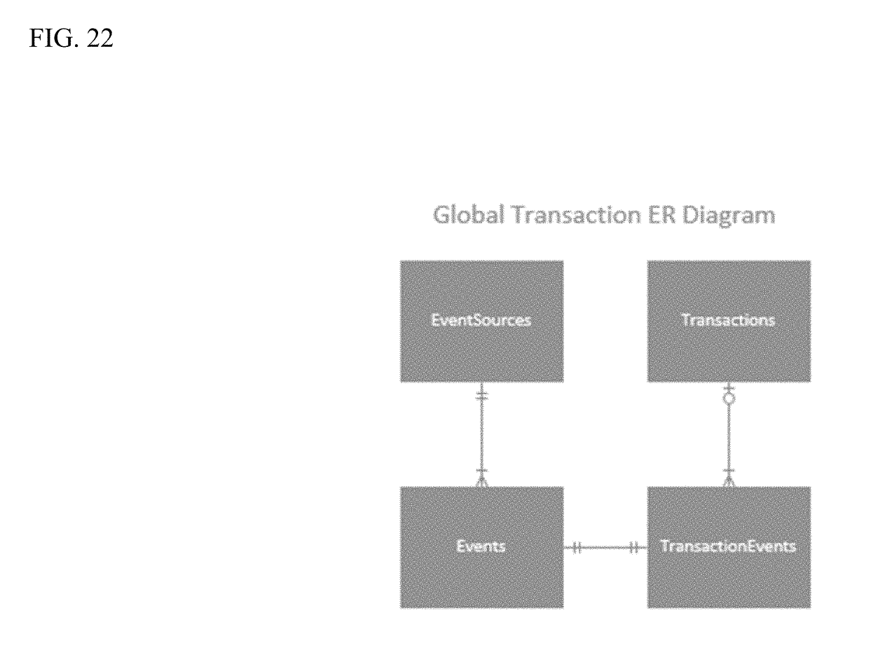

In the basic ER diagram shown in FIG. 22, you can see the relationship between the core tables/objects within the Global Transaction System. The diagram uses Crow's Foot database notation to convey the relationships.

An EventSources record has 1-to-many Events and an Event has exactly 1 EventSource. A Transaction can have 1-to-many TransactionEvents and a TransactionEvent can have 0-or-more Transactions. It is possible for a TransactionEvent to exist without a Transaction. An Event belongs to 1 TransactionEvent and a TransactionEvent can belong to exactly 1 Event.

EventSources

An EventSource identifies the source of an event. Typically, this record defines an application that intends to log events to the global transaction system.

Events

Events define the actions performed by users of an EventSource (application). Each EventSource has one or more associated Events. For example, “Send Chat” might be the name of an Event for the First Call application.

TransactionEvents

TransactionEvents are the core of the GTA. They represent the business relevant actions performed by users during an instance of providing customer service. Your application will record TransactionEvents for each Event you defined in the GTAPI. A user, and your application, will generate multiple TransactionEvents.

Transactions

A Transaction can be defined as a related collection of TransactionEvents. In most cases, Transactions are managed by the GTAPI. However, applications that integrate with the GTAPI can influence how TransactionEvents are associated to a Transaction by issuing a Starting Event or Ending Event to the TransactionEvent method. Also, the GTAPI tracks active Transactions (those currently in use by applications) via a TransactionsActive table in the GlobalTransaction database.

Users

The Users model/table is used to associate TransactionEvents to agents. This data is imported from ADA and in most cases an integrating application should not use this method. Please consult the GTAPI dev team.

UserAccounts

The UserAccounts model/table is used to associate TransactionEvents to agents.

UserPhoneLogins

The UserPhoneLogins model/table is used to associate TransactionEvents to agents.

Phone Transaction Timeline

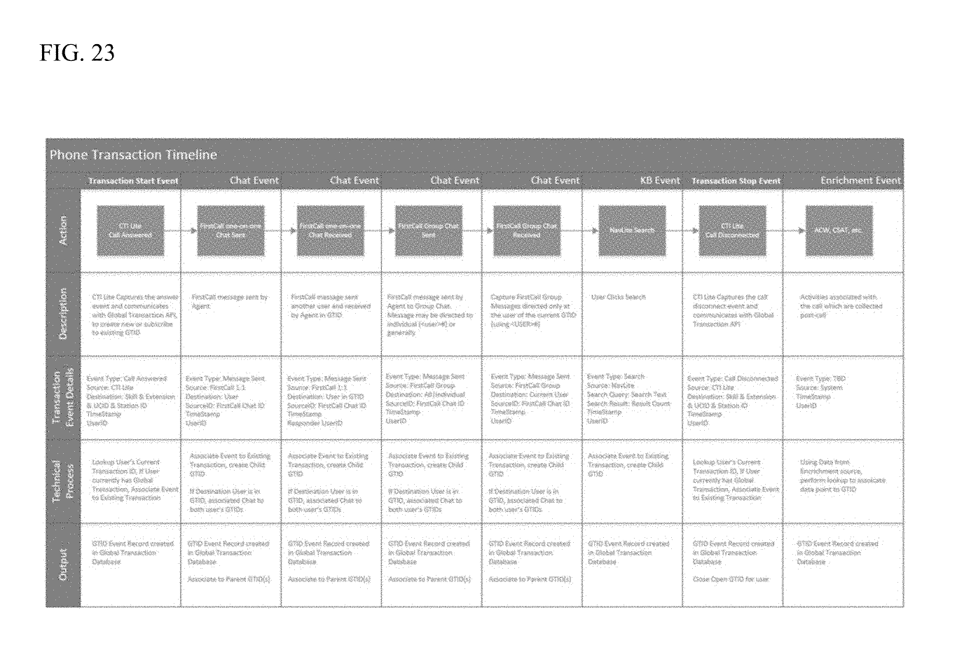

The diagram in FIG. 23 illustrates an example Phone Transaction with typical events:

Intelligent Orchestration

To manage all of the Employee Offers, scheduled tasks, and analytic work associated with the inventive platform, an intelligent workflow and orchestration system is required. This system tracks all tasks and offers currently generated by the system, as well as the time taken to complete a task or offer. Intelligent Orchestration works in conjunction with machine learning to manage employee workload and scheduling.

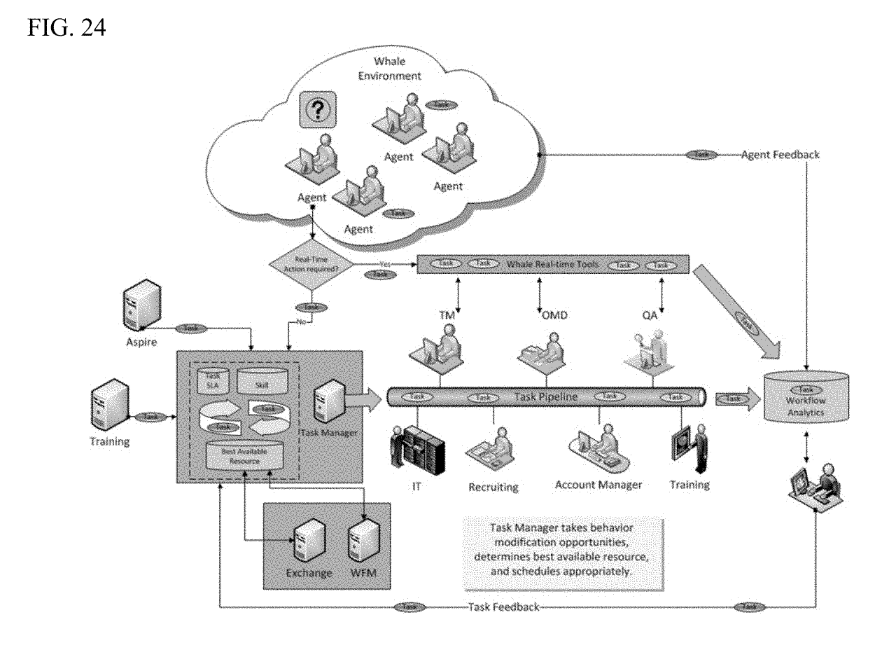

Referring now to FIG. 24, the Intelligent Orchestration goals are:
a. Intelligently route tasks to the proper employee and monitor progress of all routed tasks;
b. Schedule machine learning and human generated meetings and reschedule as necessary to meet changing business requirements; and
c. Provide employees with a workflow definition tool.

Architecture

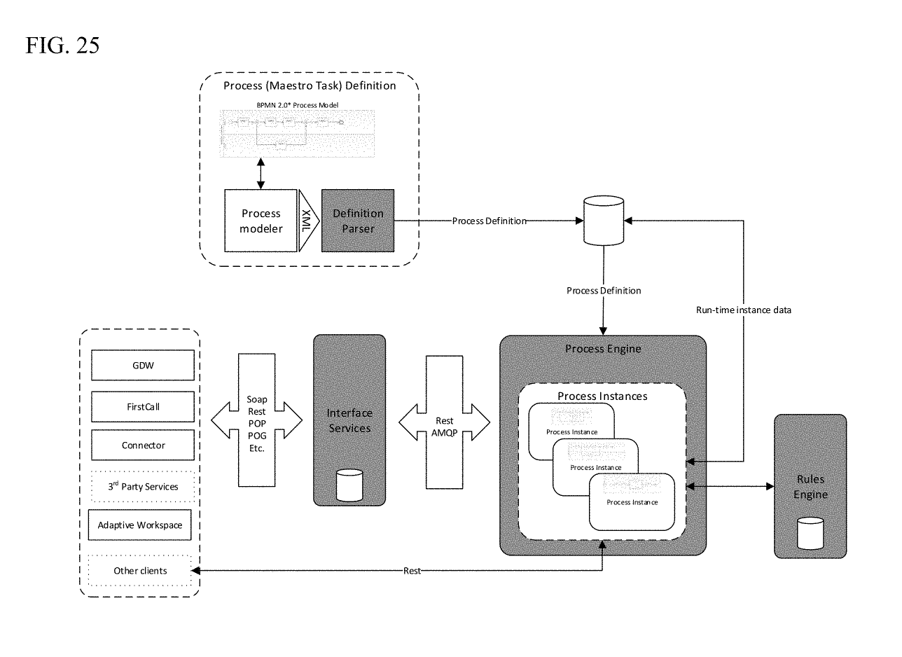

Referring now to FIG. 25, Intelligent Orchestration is a set of capabilities that support the efficient execution of workflows, or more generally, (business) processes. It is built on a layered and loosely-coupled architecture where business logic is encapsulated at the task level, enabling it to support the rapid development and reuse of complex processes and workflows. There are four main layers: (1) Process Definition, (2) Process Engine, (3) Rules Engine and (4) Interface Services.

Process Definition

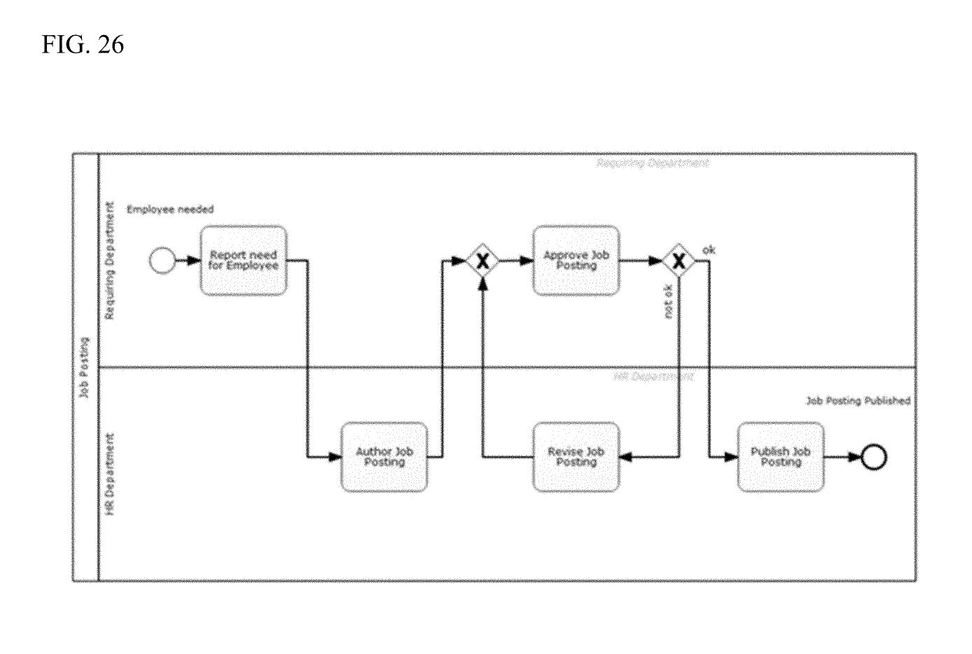

The basis of Intelligent Orchestration begins with a process model created using any visual modelling tool that supports the Object Management Group (OMG) Business Process Model and Notation (BPMN) Version 2.0 specification. Following is a sample BPMN 2.0 process model. The modeling software generates the BPMN 2.0 XML from the diagram. Process Definition will parse and convert the XML specification into a set of internal data structures that define static, definitional information (structure, flow, tasks, etc.) and runtime information used to control runtime execution and state of the process. When Intelligent Orchestration is asked to start a specific workflow, the definition for that workflow is read and a runtime process is instantiated begins execution at the starting event in the diagram shown in FIG. 26.

Process Engine

The Process Engine's primary job is to instantiate and execute process definitions. It executes a process definition using a set of workflow patterns and processing semantics. While Intelligent Orchestration does not contain nor run any business (functional) logic directly as part of its code-base, it enables it via web services or Intelligent Orchestration task behaviors that are built to perform specific business logic and are specified in the task properties. Effectively, the Process Engine will call out to the business logic then wait for its completion before continuing on with the next thing to do within the workflow.

Intelligent Orchestration continuously monitors and manages current state information all active workflows. The entire run-time context of all processes are persisted and can be restarted at the last activity in the workflow.

For every Task, The Process Engine provides the following:
a. Process timing and statistics
b. Complete audit trial of who did what and when
c. Execution authentication and roles validation
d. Persistence
e. Workflow control
f. Stateful or stateless flow-control based via the Rules Engine

Rules Engine

The Rules Engine provides the mechanism for the Process Engine to evaluate expressions in order to control the flow of the workflow via gateways, or decision points. Expressions can be as simple as checking for a specific value or more complex, involving the joining of data sets and applying a set of rules and constraints. Accessible via a REST API, Rules Engine provides:
a. Rules processing and evaluation using in-memory SQL technology
b. Proprietary communication definition to support stateless and stateful processing
c. Supports Inference Rules—Provides results for business decision support (what-if)
d. Supports Reactive Rules—Provides workflow analysis and process steps based on events (polices)
e. Supports rule add/change/delete without the need for code release
f. Changes can be imported via a document (e.g. MS Excel)
g. Changes are versioned within the Rules Engine database
h. interface to test rules before applying

Integration Services

Integration Services provide a technology-agnostic way to create reusable tasks and workflows, the ability to interact with external systems and input/output devices is critical. The Process Engine accesses all external services via a standard REST interface, with Integration Services shielding the specifics of the interface from is. It speaks many languages to the world but only one to the Process Engine.

In addition, Integration Services provide scheduling, queuing, encryption, asynchronous task handling, high-speed queues, routing, persistence and multi-protocol support. This allows Intelligent Orchestration to have a Business Process view of the world with the low-level implementation details relegated to the Integration Services layer.

All technical and scientific terms used herein have the same meaning as commonly understood by one of ordinary skill in the art to which this invention belongs, unless defined otherwise. To facilitate the understanding of this invention, a number of terms are defined below. Terms defined herein have meanings as commonly understood by a person of ordinary skill in the areas relevant to the present invention.

While the use of the inventive platform in an outsourced business service environment is provided above as an example, uses in other areas requiring customer or contact management are also possible.

Terms such as “a,” “an,” and “the” are not intended to refer to only a singular entity, but include the general class of which a specific example is used for illustration. The terminology herein is used to describe specific embodiments of the invention, but their usage does not limit the invention, except as outlined in the claims.

As used herein, an “engine” is a program that performs a core or essential function for other programs. For example, an engine may be a central program in an operating system or application program that coordinates the overall operation of other programs. The term “engine” may also refer to a program containing an algorithm that can be changed. For example, a knowledge discovery engine may be designed so that its approach to identifying relationships can be changed to reflect new rules of identifying and ranking relationships.

As used herein, “data” may be any item or information of interest (generally textual, including noun, verb, adjective, adverb, phrase, sentence, symbol, numeric characters, etc.). Therefore, data is anything that can form a relationship and anything that can be obtained, identified, and/or searched from a source. “Data” includes, but is not limited to, an asset of interest.

The terms “data” and “information” are frequently used interchangeably, as are “information” and “knowledge,” therefore, it is necessary to know the distinctions between terms. “Data” is the most fundamental unit, consisting of an empirical measurement or set of measurements. Data is compiled to contribute to information, but it is fundamentally independent of it. Information, by contrast, is derived from interests.

“Information” when referring to a data set includes numbers, sets of numbers, or conclusions resulting or derived from a set of data. “Data” is then a measurement or statistic and the fundamental unit of information. “Information” may also include other types of data such as words, symbols, text, such as unstructured free text, code, etc.

“Knowledge” is loosely defined as a set of information that gives sufficient understanding of a system to model cause and effect. To extend the previous example, information on race and diet could be used to develop a regional marketing strategy for food sales while information on height/weight ratios could be used by physicians as guidelines for diet recommendations. It is important to note that there are no strict boundaries between data, information, and knowledge; the three terms are, at times, considered to be equivalent. In general, data comes from examining, information comes from correlating, and knowledge comes from modeling.

structural changes may be made without departing from the scope of the invention

As used in the specification, and in the appended claims, the singular forms “a,” “an,” “the,” include plural referents unless the context clearly dictates otherwise.

The term “comprising” and variations thereof as used herein are used synonymously with the term “including” and variations thereof and are open, non-limiting terms.

The term “agent” includes a service provider employee that performs customer service, technical support, or other duties for the service provider clients via telephone, chat, email, social media, or other support channel

The term “Adaptive Workspace” includes an application user interface designed to deliver only the tools necessary to complete a given task. The goal is to unclutter an employee's workspace and make the work task easy to accomplish.

The term “employee tiles” includes a visual and data record representation of an employee's tenure with the service provider. Tiles allow the service provider to manage any combination of virtual and brick and mortar based employees and they provide the data input for predictive analytics models.

The term “intelligent monitor” includes a real-time predictive analytics system that proactively notifies a manager when an agent requires support.

A “relationship” refers to the co-occurrence of data within the same unit (e.g., a phrase, sentence, two or more lines of text, a paragraph, a section of a webpage, a page, a magazine, paper, book, etc.). It may be text, symbols, numbers and combinations, thereof.

As used herein, the term “database” is used to include repositories for raw or compiled data, even if various informational facets can be found within the data fields. A database is typically organized so its contents can be accessed, managed, and updated (e.g., the database is dynamic). The term “database” and “source” are also used interchangeably in the present invention, because primary sources of data and information are databases. However, generally, a “source database” or “source data” refers to data such as unstructured text and/or structured data that is input into the system for identifying data and determining relationships. A source database may or may not be a relational database. However, a system database preferably comprises a relational database or some equivalent type of database which stores values relating to relationships between data.

As used herein, a “system database” and “relational database” are used interchangeably. More specifically, a “relational database” refers to a collection of data organized as a set of tables containing data fitted into predefined categories. For example, a database table may comprise one or more categories defined by columns (e.g. attributes), while rows of the database may contain a unique object for the categories defined by the columns Thus, discrete data such as a gene, might have columns for nucleotide sequence, amino acid sequence, expression in a particular tissue or cell, organism of origin, association with a phenotype, etc. A row of a relational database may also be referred to as a “set” and is generally defined by the values of its columns. A “domain” in the context of a relational database is a range of valid values a field such as a column can contain.

As used herein, “a program,” “platform” or “computer program” is generally a syntactic unit that conforms to the rules of a particular programming language and that is composed of declarations and statements or instructions, divisible into, “code segments” needed to solve or execute a certain function, task, or problem. A programming language is generally an artificial language for expressing programs.

A “system” or a “computer system” generally includes one or more computers, peripheral equipment, and software that perform data processing. A “user” or “system operator” in general includes a person, that utilizes a computer network accessed through a “user device” (e.g., a computer, a wireless device, etc) for the purpose of data processing and information exchange. A “computer” is generally a functional unit that can perform substantial computations, including numerous arithmetic operations and logic operations without human intervention.

“Application software” or an “application program” is, in general, software or a program that is specific to the solution of an application problem. An “application problem” is generally a problem submitted by an end user and requiring information processing for its solution.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

1. (canceled)

2. A call manager coupled to a packet-based network and operable to control a plurality of devices, the call manager comprising the following logic embodied in a computer-readable medium:
a. providing an event source database, transactions database, events database and transaction events database;
b. receiving a transaction event from a client;
c. storing transaction and event source details in the transaction and event source database;
d. inserting the transaction event in the transaction database responsive to the presence of a transaction ID;
e. performing a user identity translation for the event source responsive to the lack of a transaction ID
f. determining if an active transaction has been received;
g. responsive to determining that an active transaction has been received;
i. determining if the active transaction event is an end event or a start event;
1. responsive to a determination that the active transaction is a start event;
a. Deleting an existing active transaction;
b. Inserting a new transaction into a transaction database;
c. Inserting a new active transaction into the transaction database; and
d. Inserting a new transaction event into the transaction event database.
2. deleting the active transaction responsive to a determination that the active transaction event is an end event;
h. responsive to determining that an active transaction has not been received;
i. determining if the active transaction event is an end event or a start event;
1. responsive to a determination that the active transaction is a start event;
a. inserting a new transaction in the transaction database;
b. inserting a new active transaction in the transaction database; and
c. inserting a new transaction event in the transaction event database; and
2. responsive to a determination that the active transaction is an end event;
a. inserting a new transaction event in the transaction event database.
